(19) United States
(12) Patent Application Publication
(10) Pub. No.: US 2024/0211056 A1
(43) Pub. Date: Jun. 27, 2024

(54) METHOD AND APPARATUS FOR DETERMINING AN INDICATION OF A POINTED POSITION ON A DISPLAY DEVICE

(71) Applicant: InterDigital CE Patent Holdings, SAS, Pris (FR)

(72) Inventors: Sylvain Thiebaud, Noyal sur Vilaine (FR); Patrick Morvan, Laille (FR); Sylvain Lelievre, Montgermont (FR); Thomas Morin, Saint-Gregoire (FR)

(21) Appl. No.: 18/288,269

(22) PCT Filed: Apr. 26, 2022
(86) PCT No.: PCT/EP2022/061018

§ 371 Date: Oct. 25, 2023

(30) Foreign Application Priority Data
Apr. 29, 2021 (EP) 21305556.9

(51) Int. Cl. G06F 3/0346; G06F 3/04845; G06T 7/70; G06T 11/60

(52) U.S. Cl. CPC G06F 3/0346; G06F 3/04845; G06T 7/70; G06T 11/60

(57) ABSTRACT

According to an embodiment, a direction pointed by a controlling device with a first orientation may be obtained from a first image of a user handing the controlling device with the first orientation. For example, an initial indication of an initial pointed position may be displayed on a display device based on the direction. For example, angular information may be obtained. The angular information may be representative of a difference between the first orientation and a second orientation of the controlling device pointing to the pointed position. For example, an indication of a pointed position may be determined (e.g., for display) based on the initial pointed position and on the received angular information.

### 1. TECHNICAL FIELD

The present disclosure relates to the domain of remote control of devices by a user, more particularly to the emulation of laser pointers with a controlling device.

### 2. BACKGROUND ART

Laser pointers may be used to show some elements, for example, during a presentation. Laser pointers are small handheld devices that project a coloured laser light that may be used to point at a desired target location of a display with a high level of accuracy. Laser pointers may be emulated by remote controls or smartphones, but emulated laser pointers generally do not provide the same level of accuracy as (e.g., real) laser pointers. The present disclosure has been designed with the foregoing in mind.

### 3. SUMMARY

According to an embodiment, a direction pointed by a controlling device with a first orientation may be obtained from a first image of a user handing the controlling device with the first orientation. For example, a first indication of a first pointed position may be determined (e.g., for display on a display device) based on the direction. For example, angular information may be obtained (e.g., received from the controlling device). The angular information may be representative of (e.g., may indicate a difference between) the first orientation and a second orientation of the controlling device pointing to a second pointed position. For example, an indication of the second pointed position may be determined (e.g., for display on the display device) based on the first pointed position and on the obtained (e.g., received) angular information.

### 4. BRIEF DESCRIPTION OF THE DRAWINGS

FIG. 1 is a system diagram illustrating an example of a display device displaying an indication of a pointed position;

FIG. 2 is a system diagram illustrating another example of a display device displaying an indication of a pointed position;

FIG. 3 illustrates a first example of an image processing method for obtaining an initial pointed position on a display device, based on a 3D pose estimation of a user;

FIG. 4 illustrates a second example of an image processing method for obtaining an initial pointed position on a display device;

FIG. 5 is a diagram illustrating three orientations that may be provided by the inertial measurement unit (IMU) of the controlling device;

FIG. 6 is a diagram illustrating an example of a display device and an example of angular information that may be obtained from the controlling device according to an embodiment;

FIG. 7 is a diagram illustrating an example of a display device and an example of angular information that may be obtained from the controlling device according to another embodiment;

FIG. 8 is a diagram illustrating an example of a processing device for displaying an indication of a pointed position on a display device;

FIG. 9 represents an exemplary architecture of the processing device described in FIG. 8;

FIG. 10 is a diagram illustrating an example of a method for displaying an indication of a pointed position on a display device; and

FIG. 11 is a diagram illustrating an example of a method for determining an indication of a pointed position on a display.

It should be understood that the drawing(s) are for purposes of illustrating the concepts of the disclosure and are not necessarily the only possible configuration for illustrating the disclosure.

### 5. DESCRIPTION OF EMBODIMENTS

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the term “interconnected” is defined to mean directly connected to or indirectly connected with through one or more intermediate components. Such intermediate components may include both hardware and software-based components. The term “interconnected” is not limited to a wired interconnection and also includes wireless interconnection.

All examples and conditional language recited herein are intended for educational purposes to aid the reader in understanding the principles of the disclosure and the concepts contributed by the inventor to furthering the art and are to be construed as being without limitation to such specifically recited examples and conditions.

Moreover, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

It is to be appreciated that the use of any of the following “I”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Embodiments described herein are related to controlling devices that may be used as laser pointers on display devices. Any kind of controlling device, such as e.g., any kind of remote control or smartphone may be applicable to embodiments described herein. Any kind of display devices, such as e.g., without limitation, any of a (e.g., TV) screen, a display surface, etc . . . may be applicable to embodiments described herein. The terms “display device” and “display”, collectively “display” may be used interchangeably throughout embodiments described herein to refer to any kind of display system.

The terms “initial position” and “first position” may be used interchangeably throughout embodiments described herein. The terms “initial pointed position” and “first pointed position” may be used interchangeably throughout embodiments described herein. The terms “initial indication” and “first indication” may be used interchangeably throughout embodiments described herein.

The terms “position” and “second position” may be used interchangeably throughout embodiments described herein. The terms “pointed position” and “second pointed position” may be used interchangeably throughout embodiments described herein. The terms “indication” and “second indication” may be used interchangeably throughout embodiments described herein.

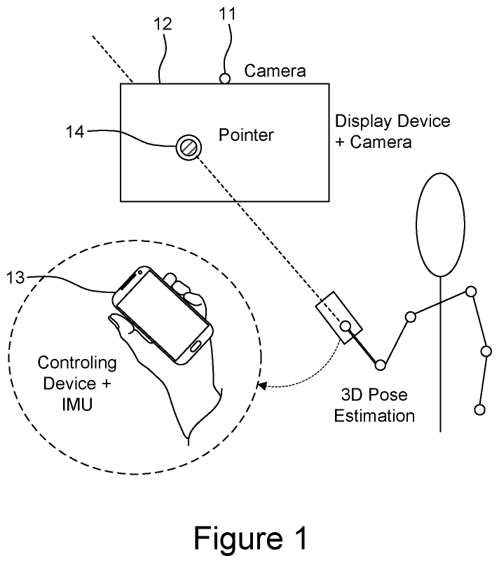

FIG. 1 is a system diagram illustrating an example of a display device displaying an indication of a pointed position. A pointer 14 may be emulated on a display device 12 based on an (e.g., absolute) position that may be pointed by a controlling device 13 (e.g., handed by a user) on the display device 12. A position 14 on the display device 12 that may be pointed by the controlling device 13 may be referred to herein as a pointed position. For example, it may be determined whether a controlling device 13 (e.g., handed by a user) is pointing to the display device 12 based on a (e.g., 3D) pose estimation of the user, that may be based on image processing. For example, determining a pointed position on the display device based on a (e.g., image processing based) pose estimation may be further based on a projection along a given direction. The projection of a given position (e.g., in space) to the display device along the given direction may amplify any error in any of the given position estimation and the direction estimation. The stability and the accuracy of such a processing (e.g., only based on image processing) may remain limited and may not allow to manage a pointer working as a laser pointer (e.g., very accurately).

According to embodiments, controlling devices such as e.g., smart phones may embed an inertial measurement unit (IMU), which may be referred to herein as sensor and that may provide accurate angle information representing the orientation of the controlling devices. An IMU may comprise any number of sensors, such as e.g., any of an accelerometer sensor, a gyroscopic sensor, and a gravity sensor (collectively sensor). Angle information e.g., provided by an IMU may be relative (e.g., representing orientation variations, differences) and may not allow to provide an (e.g., absolute) pointed direction on the display device. Throughout embodiments described herein the terms orientation, angle, angular information may be used interchangeably to represent angle(s) between given orientation(s) and reference orientation(s).

For example, a camera 11 may be built (e.g., embedded) in the display device 12. The camera 11 and the display device 12 may be associated with the (e.g., IMU of the) controlling device 13 to manage the pointer (e.g., determine a pointed position on the display device) in an absolute manner and (e.g., very) accurately. In another example (not illustrated) the camera may not be embedded in the display device and may be located at any (e.g., known) position relative to the display device. The pointed position may be further determined based on the relative position of the camera to the display device.

According to embodiments, there may be two sensor domains: a first sensor domain corresponding to the camera may be built in (e.g., or relative to) the display device. A second sensor domain corresponding to the IMU of the controlling device may be built in the controlling device. The display device camera domain may indicate whether the (e.g., user handing the) controlling device is pointing at the display device. Based on image processing, this indication alone may not be stable and accurate enough (e.g., due to position/direction errors amplified by the projection) to drive a pointer accurately on the display device. The controlling device IMU domain may provide more accurate information, allowing to drive the pointer, in relative position. Combining these two sensor domains may allow to manage (e.g., emulate) the pointer accurately, in absolute position on the display device, for example, without any preliminary learning or configuration operation.

According to embodiments, a relationship may be established between the display device camera domain and the controlling device IMU domain. This relationship may be established by associating a first initial orientation information (which may be referred to herein as do) in the camera domain, and a second initial orientation information (which may be referred to herein as αY_{aw0}/αP_{ITCH0}) in the controlling device IMU domain. The association of the first initial orientation information do with the second initial orientation information αY_{aw0}/αP_{ITCH0} may allow to determine accurate pointed positions on the display device without any preliminary learning or configuration process.

For the sake of simplicity, embodiments are described herein with a display device displaying one or more indications of one or more pointed positions on the display device. Any processing device configured to determine the one or more indications of the one or more pointed positions on the display device for display on the display device may be applicable to embodiments described herein. For example, a processing device different from the display device, such as e.g., a set-top-box to be connected to a display device may be configured to determine indication(s) of pointed position(s) on the display device for being displayed on the display device according to any embodiment described herein. The expressions “displaying an indication on the display device” and “determining an indication for display on the display device” may be used interchangeably throughout embodiments described herein.

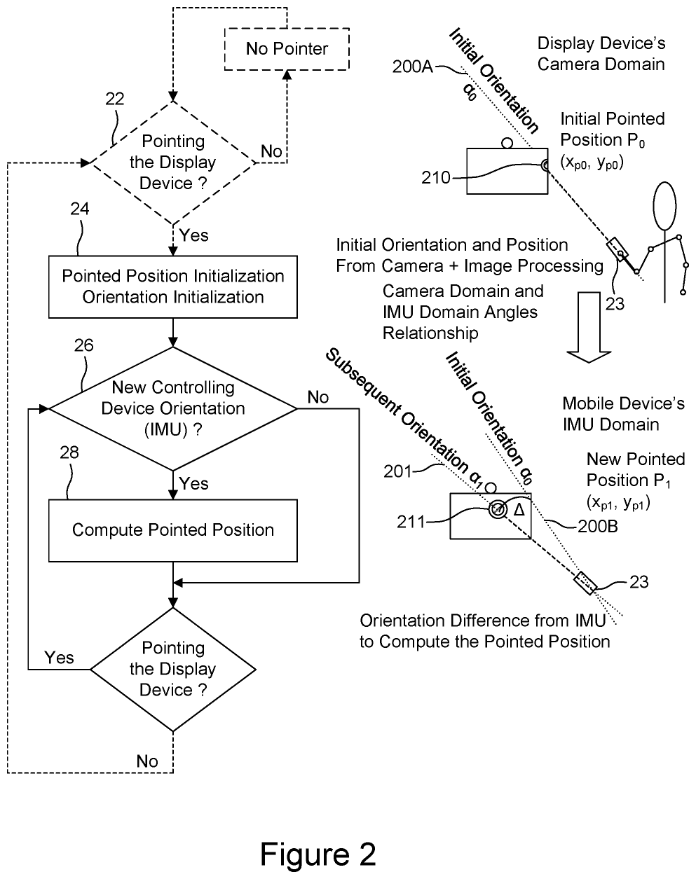

FIG. 2 is a system diagram illustrating another example of a display device displaying an indication of a pointed position.

For example, a direction that may be pointed by a controlling device 23 with a first initial orientation 200A may be obtained based on an image processing of a first image of a user handing the controlling device 23 with the initial orientation. An initial pointed position 210 on the display device (e.g., or in the plane of the display device) may be determined based on the direction.

For example, a second initial orientation 200B may be obtained based on angular information that may be obtained from the IMU of the controlling device 23 in the same initial orientation.

For example, in a step 24, the orientation may be initialized by initializing the second initial orientation 200B (e.g., in the controlling device IMU domain) to the first initial orientation 200A (e.g., in the display device camera domain).

For example, in a step 26 it may be determined whether the controlling device changed of orientation (e.g., from the initial orientation to a subsequent orientation 201).

In a step 28, a (e.g., subsequent) pointed position 211 on the display device may be obtained based on the initial pointed position and on angular information representative of the initial orientation 200A 200B and the subsequent orientation 201 of the controlling device pointing to the (e.g., subsequent) pointed position 211. For example, the angular information may be obtained (e.g., received) from the (e.g., IMU of the) controlling device. For example, the angular information may indicate a difference between the initial orientation 200A 200B and the subsequent orientation 201 of the controlling device pointing respectively to the initial and the (e.g., subsequent) pointed position 211. In another example, the angular information may indicate a first value associated with (e.g., representative of) the initial orientation 200A 200B and a second value associated with (e.g., representative of) the subsequent orientation 201. Any kind of angular information (e.g., format) representative of a difference between a first and a second orientations of the controlling device pointing respectively to a first and a second pointed positions may be applicable to embodiments described herein.

In an (e.g., initial optional) step 22, it may be determined whether the controlling device 23 is pointing at the display device. For example, it may be determined whether the direction pointed by the controlling device intersects the display device (e.g., at the initial pointed position). In a first example, if it is determined that the controlling device 23 is pointing at the display device, an initial indication may be displayed at the center of the display device. In a second example, if it is determined that the controlling device is pointing at the display device, an initial indication may be displayed at the initial pointed position 210 on the display device.

According to embodiments, the initial pointed position 210 on the display device may be obtained based on a processing of at least one image of the user handing the controlling device 23 in the initial orientation 200A, 200B. For example, image(s) may be obtained from any of 3D cameras and 2D cameras that may be any of embedded in the display device and external to the display device (e.g., located at a known relative position to the display device). Different image processing techniques may be used to obtain the initial pointed position 210 from at least one image of a user handing the controlling device 23.

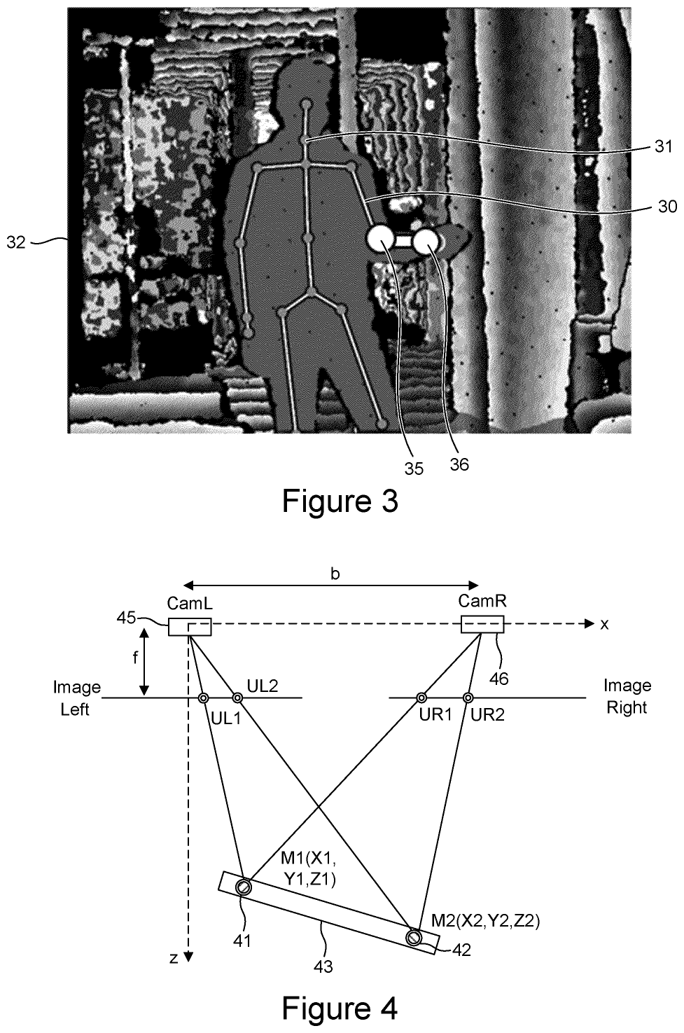

FIG. 3 illustrates a first example of an image processing method for obtaining an initial pointed position on a display device, based on a 3D pose estimation of a user. For example, the pose of a forearm of a user may be obtained based on a pose estimation method. According to embodiments, the pose may be obtained (e.g., estimated), based on e.g., a colour+depth image 32 of a user. For example, a depth map may comprise depth information for (e.g., each) points of the colour image. Relative positions between body parts of a user (e.g., limbs, joints between limbs) may be obtained based on the depth map (e.g., possibly combined with the colour image), for example, by applying a machine learning (or deep learning) technique. For example, a user map may be obtained by analysing the output of a e.g., RGB and depth output of a camera for any user in the field of view of the camera. The user map may comprise, for example, any of a silhouette and (e.g., 3D) positions of any number of skeleton joints 30. The positions of respectively the wrist 36 and the elbow 35 may be obtained based on the skeleton 30, as illustrated in FIG. 3.

For example, positions (e.g., in 3D space) of any number of joints 31 of the user may be obtained, e.g., from the user map. For example, the (e.g., pointed direction) may be obtained by the line extending the segment comprising the (e.g., 3D) positions of the user's wrist 36 and elbow 35. Based on the position of the camera in (e.g., or relative to) the display device and the size of the display device, it may be determined whether the controlling device is pointing at the display device, and to which position on the display device (or to any position in the plane of the display device). The initial pointed position (which may be referred to herein as P₀) may be obtained, for example by a projection of the line originating from the elbow joint 35 and going through the wrist joint 36 on the display device. For example, an indicator (such as e.g., a pointer spot) may be displayed at the initial pointed position P₀.

According to embodiments, the system may be configured for detecting the pointed direction of any of the right and left arm. In a first example, the system may be pre-configured. In a second example, the system may be configured via a user interface. In a third example, the configuration (e.g., of any of the right and left arm as the pointing arm) may be automatic. The system may, for example, learn (e.g., based on most frequent posture detection), which of the right or left arm may be the pointing arm.

FIG. 4 illustrates a second example of an image processing method for obtaining an initial pointed position on a display device. For example, the controlling device 43 may include any number of markers 41, 42, located at respective positions which may be referred to herein as M1(X₁, Y₁, Z₁) and M2(X₂, Y₂, Z₂). For example, a left image and a right image of the user handing the controlling device may be obtained by respectively a left camera 45 and a right camera 46, that may be separated from each other by a distance which may be referred to herein as a baseline b. The first marker 41 may be projected as first projected points UL1, UR1 on respectively the left image and the right image. The second marker 42 may be projected as second projected points UL2, UR2 on respectively the left image and the right image. The disparity d may be defined as the horizontal distance between the two projected points of a same marker (d=UL1x−UR1x). The positions M1(X₁, Y₁, Z₁) and M2(X₂, Y₂, Z₂) of respectively the first 41 and the second 42 markers may be obtained based on the positions of the projected points of the markers on the left and right images, the baseline b, and the focal length of the cameras 45, 46. For example, the position M1(X₁, Y₁, Z₁) may be obtained based on the following relationships between following parameters:
d=U_{L1x}−U_{R1x} (e.g., for obtaining the disparity based on the horizontal distance between two projected points of the first marker);
Z₁=(f×b)/d (e.g., for obtaining the depth Z₁ of the first marker based on the disparity;
U_{L1x}/f=X₁/Z₁ (e.g., for obtaining the horizontal position X₁ of the first marker based on the left image);
U_{L1y}/f=Y₁/Z₁ (e.g., for obtaining the vertical position Y₁ of the first marker based on the left image);

For example, the second marker position M2(X₂, Y₂, Z₂) may be obtained similarly.

For example, a pointed direction may be obtained based on the obtained marker positions and on where the markers are located on the controlling device with regards to the geometry of the controlling device.

More generally any image processing method allowing to obtain an initial position of the controlling device and an initial pointed position on the display device by processing an image of a user handing the controlling device and pointing to the display device may be applicable to embodiments described herein.

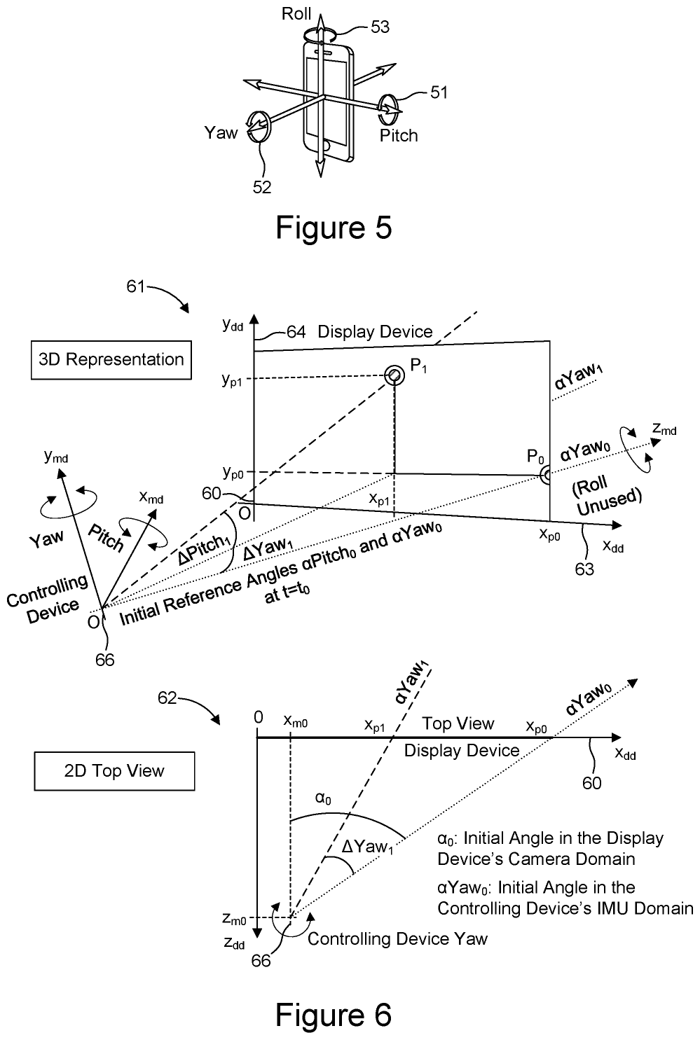

FIG. 5 is a diagram illustrating three orientations that may be provided by the IMU of the controlling device. For example, the IMU of the controlling device may provide three angles with regards to three references: the pitch 51, the yaw 52, and the roll 53, representing the (e.g., 3D, overall) orientation of the controlling device. According to embodiments, (e.g., only) the pitch orientation and the yaw orientation may be used. The angle Δ illustrated in FIG. 2 representing the difference between the initial orientation and the subsequent orientation of the controlling device may be a combination of two angles ΔPitch and ΔYaw, as illustrated in FIG. 6.

FIG. 6 is a diagram illustrating an example of a display device and an example of angular information that may be obtained from (e.g., the IMU of) the controlling device according to an embodiment. A first view 61 is a 3D representation of the controlling device position and orientation relative to the display device. To simplify the representation, a second view 62 represents a top view of the display device and controlling device position (and orientation) in 2D. In the top view 62, only the yaw angle is illustrated, corresponding to the horizontal pointed position of e.g., an indicator that may move along the display device horizontal axis 63. A similar processing may be performed vertically, considering the pitch angle and the vertical display device axis 64.

For example, the origin 60 of the display device coordinate system (O, x_{dd}, y_{dd}, z_{dd}) may be placed at the bottom left of the display device. For example, to simplify the representation, the camera may be located at this origin 60. For any other position of the camera on the display device, a (e.g., 2D) translation may be applied according to the position of the camera.

For example, a Yaw rotation of the controlling device (e.g., from a first to a second orientation) may correspond to an angle Δa and a displacement Δx along the horizontal axis 63. For example, a Pitch rotation may correspond to an angle Δβ and a displacement Δy along the vertical axis 64. According to embodiments, an angular information indicating any of a yaw rotation and a pitch rotation may be used to obtain a pointed position.

In an embodiment, any translation of the controlling device may be ignored and a subsequent position pointed by the controlling device may be solely determined based on angular information (e.g., of the IMU) of the controlling device and on the initial position of the controlling device. By subsequent pointed position, it is meant any position pointed by the controlling device that may be subsequent to an initial pointed position. Approximating the controlling device to pure rotations may allow to simplify the processing while keeping a good level of accuracy. Indeed, in many situations a user pointing at a display device may mainly rotate the controlling device without translating it.

In this embodiment, the initial position 66 of the controlling device may be considered as constant, and may be referred to herein as (xₘ₀, yₘ₀, zₘ₀).

For example, at time t=t0 (e.g., after the controlling device may be pointing at the display device), the initial pointed position on the display device (which may be referred to herein as P₀ (X_{P0}, y_{P0}) may be obtained by, for example, projecting a direction pointed by the controlling device in the plane of the display device. For example, the direction pointed by the controlling device may be a line between the user's wrist and elbow or any line between two markers embedded in the controlling device. For example, the initial position of the controlling device (xₘ₀, yₘ₀, zₘ₀) relatively to the display device may be provided by the position of any of the wrist of the user, the hand of the user, and a marker embedded in the controlling device. The initial orientation (e.g., angle) α₀ may be computed in the display device domain according to the following equation:

$${α}_{0} = {tan}^{- 1} ( \frac{{x}_{P 0} - {x}_{m 0}}{{z}_{m 0}} )$$

In the controlling device IMU domain, the initial orientation (e.g., angle) αY_{aw0} may be obtained from the IMU. The initial angle do in the display device domain may correspond to the initial angle αY_{aw0} in the controlling device IMU 30) domain. Any (e.g., all) angle (e.g., orientation) modifications in the controlling device domain may be computed relatively to this initial angle αY_{aw0} to determine any subsequent pointed position (e.g., and indicator displacement).

After the controlling device (e.g., IMU) may have moved from the initial orientation (e.g., corresponding to angle αY_{aw0}) to a second orientation (e.g., corresponding to angle αY_{aw1}, a (e.g., subsequent) pointed position may be obtained on the display device and may be referred to herein as P₁ (x_{P1}, y_{P1}). In this embodiment, the controlling device may have only rotated and may still be located at the initial position (xₘ₀, yₘ₀, zₘ₀). The horizontal pointed position may be obtained according to the following equations:

$${x}_{P 1} = {z}_{m 0} \cdot tan ( {α}_{0} - Δ {Yaw}_{1} )$$

Considering αY_{aw0} may be the IMU reference angle, the angle displacement (e.g., difference, variation) ΔYaw1 of the controlling device between the initial orientation (e.g., at an initial time t0) and a second orientation (e.g., at a subsequent time t1) may be given by:

$$Δ {Yaw}_{1} = α {Yaw}_{1} - α {Yaw}_{0}$$

$${x}_{P 1} = {z}_{m 0} \cdot tan ( {tan}^{- 1} ( \frac{{x}_{P 0} - {x}_{m 0}}{{z}_{m 0}} ) + α {Yaw}_{0} - α {Yaw}_{1} )$$

In other words, the initial position (xₘ₀, yₘ₀, zₘ₀) of the controlling device relatively to the display device may be obtained based on processing an image of the user handing the controlling device in the initial orientation. The initial orientation (e.g., angle) α₀ in the horizontal plane may be computed (e.g., in the display device domain) as the inverse tangent of the difference between the horizontal pointed position x_{P0} and the initial horizontal position xₘ₀ of the controlling device divided by the initial depth position zₘ₀ of the controlling device. The horizontal pointed position x_{P1} may be obtained by the initial depth position zₘ₀ of the controlling device multiplied by the tangent of an angle corresponding to the difference between the initial angle do and the difference ΔYaw1 between the initial yaw orientation and a second yaw orientation (e.g., respectively the initial and second orientations in the IMU domain wrt the yaw reference) of the controlling device pointing to the pointed position P₁.

For example, the vertical pointed position y_{P1} may be computed in a similar way, by e.g., considering the vertical positions of the controlling device, and Pitch angle information obtained from the IMU:

$${y}_{P 1} = {z}_{m 0} \cdot tan ( {tan}^{- 1} ( \frac{{y}_{P 0} - {y}_{m 0}}{{z}_{m 0}} ) + α {Pitch}_{0} - α {Pitch}_{1} )$$

In other words, the initial orientation (e.g., angle) α₀ may be computed (e.g., in the display device domain) in the vertical plane as the inverse tangent of the difference between the vertical pointed position y_{P0} and the initial horizontal position yₘ₀ of the controlling device divided by the initial depth position zₘ₀ of the controlling device. The vertical pointed position y_{P1} may be obtained by the initial depth position zₘ₀ of the controlling device multiplied by the tangent of an angle corresponding to the difference between the initial angle do and the difference ΔPitch1 between the initial pitch orientation and a second pitch orientation (e.g., respectively the initial and second orientations in the IMU domain wrt the pitch reference) of the controlling device pointing to the pointed position P₁.

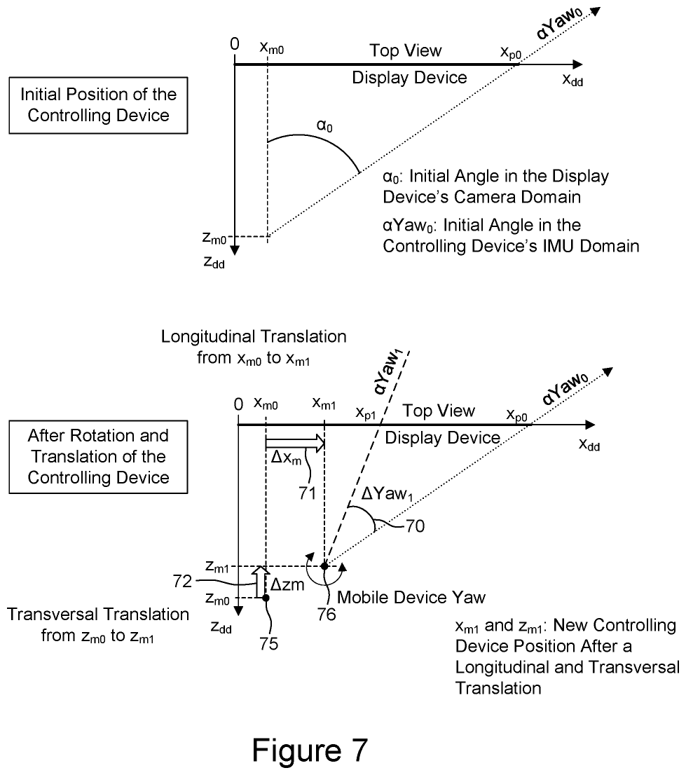

FIG. 7 is a diagram illustrating an example of a display device and an example of angular information that may be obtained from (e.g., the IMU of) the controlling device according to another embodiment. In this embodiment, a translation of the controlling device may be considered in addition to a rotation to determine a subsequent pointed position. Determining a subsequent pointed position based on both translation and rotation information may allow to improve the accuracy of the pointed position determination. For example, a (e.g., new, subsequent) position 76 of the controlling device may be determined after the controlling device moved (e.g., translated) from the initial position 75 to the (e.g., new, subsequent) position 76. The (e.g., new, subsequent) position 76 may be obtained by a processing of a (e.g., new, subsequent) image of the user handing the controlling device at the (e.g., new, subsequent) position 76. The (e.g., new, subsequent) position 76 may be obtained similarly as the initial position 75 of the controlling device (e.g., using any image processing technique). FIG. 7 describes an example of an angular displacement 70 (e.g., rotation) ΔYaw1 wrt to the Yaw reference, a longitudinal (e.g., horizontal) translation 71 Δxm and a transversal (e.g., depth) translation 72 Δzm.

For example, the initial angle do in the display device domain may be obtained as described in the example of FIG. 6, e.g., according to the following equation:

$${α}_{0} = {tan}^{- 1} ( \frac{{x}_{P 0} - {x}_{m 0}}{{z}_{m 0}} )$$

For example, a (e.g., new, subsequent) pointed position P₁ (x_{P1}, y_{P1}) may be obtained after the controlling device may have moved from the initial position 75 (xₘ₀, yₘ₀, zₘ₀) to the (e.g., new, subsequent) position 76 (xₘ₁, yₘ₁, zₘ₁). The movement of the controlling device from the initial position 75 (xₘ₀, yₘ₀, zₘ₀) to the (e.g., new, subsequent) position 76 (xₘ₁, yₘ₁, zₘ₁) may comprise any of a longitudinal translation, a transversal translation, and a rotation (from an initial angle αYaw0 to a subsequent angle αYaw1), as illustrated in FIG. 7. The (e.g., new, subsequent) horizontal pointed position xₚ₁ may be given by the following equations:

$${x}_{P 1} = {x}_{m 1} + {z}_{m 1} \cdot tan ( {α}_{0} - Δ {Yaw}_{1} )$$

In other words, the horizontal pointed position x_{P1} may be obtained by adding the (e.g., new, subsequent) horizontal position xₘ₁ of the controlling device to the (e.g., new, subsequent) depth position zₘ₁ of the controlling device multiplied by the tangent of an angle corresponding to the difference between the initial angle do and the difference ΔYaw1 between the initial yaw orientation and a second yaw orientation (e.g., respectively the initial and second orientations in the IMU domain wrt the yaw reference) of the controlling device pointing to the pointed position P₁. The vertical pointed position y_{P1} may be obtained in a same way, e.g., by adding the (e.g., new, subsequent) vertical position yₘ₁ of the controlling device to the (e.g., new, subsequent) depth position zₘ₁ of the controlling device multiplied by the tangent of an angle corresponding to the difference between the initial angle do and the difference ΔPitch1 between the initial pitch orientation and a second pitch orientation (e.g., respectively the initial and second orientations in the IMU domain wrt the pitch reference) of the controlling device pointing to the pointed position P₁.

More formally, considering αYaw0 as the IMU reference angle, the angle displacement ΔYaw1 of the mobile device between an initial time to and a subsequent time t1 may be given by:

$$Δ {Yaw}_{1} = α {Yaw}_{1} - α {Yaw}_{0}$$

$${x}_{P 1} = {x}_{m 1} + {z}_{m 1} \cdot tan ( {tan}^{- 1} ( \frac{{x}_{P 0} - {x}_{m 0}}{{z}_{m 0}} ) + α {Yaw}_{0} - α {Yaw}_{1} ) \\ {y}_{P 1} = {y}_{m 1} + {z}_{m 1} \cdot tan ( {tan}^{- 1} ( \frac{{y}_{P 0} - {y}_{m 0}}{{z}_{m 0}} ) + α {Pitch}_{0} - α {Pitch}_{1} )$$

In a first example, the (e.g., new, subsequent) position 76 (xₘ₁, yₘ₁, zₘ₁) of the controlling device may be obtained (e.g., computed) in a same way as the initial position 75 (xₘ₀, yₘ₀, zₘ₀) of the controlling device may have been obtained.

In a second example, the (e.g., new, subsequent) position 76 (xₘ₁, yₘ₁, zₘ₁) of the controlling device may be obtained from translation information that may be received from the controlling device, indicating that the controlling device may have translated from the initial position 75 to the (e.g., new, subsequent) position 76 for pointing to the pointed position P₁. For example, translation information may include measurement data that may be obtained from the IMU embedded in the controlling device. The IMU may comprise any number of sensors such as any of an accelerometer sensor, a gyroscopic sensor and a gravity sensor. For example, the (e.g., new, subsequent) position 76 (xₘ₁, yₘ₁, zₘ₁) of the controlling device may be obtained based on measurement data originating from any sensor of the IMU.

The measurement data may include, for example, any of acceleration information (e.g., originating from the accelerometer sensor) and orientation information (e.g., originating from the gyroscope sensor). Acceleration information may comprise an acceleration vector (e.g., accelerators signals) that may be resolved into global coordinates based on the orientation information (e.g., the acceleration vector may be projected onto the x,y,z coordinate system of the display device). For example, the projected acceleration may be corrected by subtracting gravity acceleration (e.g., originating from the gravity sensor). The corrected projected acceleration may be integrated to obtain velocity information, that may be integrated to obtain a new position relative to the initial position (e.g., translation information), based on an initial velocity. In a first example, the initial velocity may be considered as null. In a second example, the initial velocity may be obtained from a previous acceleration integration. In a third example, the initial velocity may be obtained by obtaining successive positions of the controlling device based on an image processing of two consecutive images of the user handing the controlling device.

The processing of the measurement data to obtain translation information (e.g., the new position relative to the initial position) may be performed in any of the controlling device (e.g., including processed measurement data e.g., as described herein, in transmitted translation information) and in the display device (e.g., receiving raw measurement data in the translation information and processing the raw measurement data e.g., as described herein).

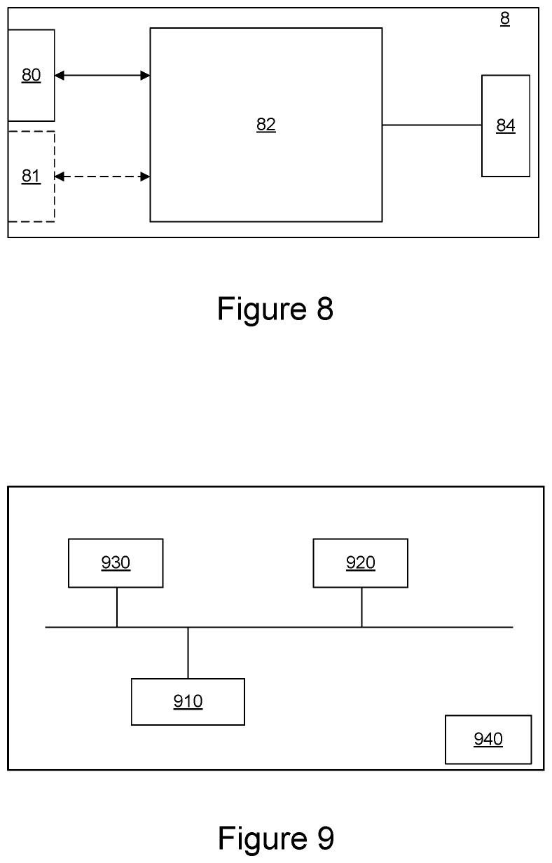

FIG. 8 is a diagram illustrating an example of a processing device 8 for displaying an indication of a pointed position on a display device. According to embodiments, the processing device 8 may comprise a network interface 80 for connection to a network. The network interface 80 may be configured to send and receive data (e.g., packets) for receiving (e.g., any of angular and translation) information from a controlling device. According to embodiments, the network interface 80 may be any of:
a wireless local area network interface such as Bluetooth, Wi-Fi in any flavour, or any kind of wireless interface of the IEEE 802 family of network interfaces;
a wired LAN interface such as Ethernet, IEEE 802.3 or any wired interface of the IEEE 802 family of network interfaces;
a wired bus interface such as USB, FireWire, or any kind of wired bus technology.
a broadband cellular wireless network interface such a 2G/3G/4G/5G cellular wireless network interface compliant to the 3GPP specification in any of its releases;
a wide area network interface such a xDSL, FFTx or a WiMAX interface.

More generally, any network interface allowing to send and receive data may be applicable to embodiments described herein.

According to embodiments, the processing device 8 may comprise an optional sensor 81 (that may be internal or external to the processing device 8). The sensor 81 (such as e.g., a camera) may be configured to obtain at least one image of a user handing (e.g. and pointing) a controlling device.

According to embodiments, the network interface 80 and the optional 20) sensor 81 may be coupled to a processing module 82, configured to obtain a direction pointed by a controlling device with a first orientation, the direction being obtained from a first image of a user handing the controlling device with the first orientation. According to embodiments, the processing module 82 may be configured to determine (e.g., for display) an initial indication of an initial pointed position on the display device based on the direction. According to embodiments, the processing module 82 may be configured to obtain (e.g., receive) angular information from the controlling device, the angular information being representative of (e.g., indicating a difference between) the first orientation and a second orientation of the controlling device pointing 30) respectively to the initial pointed position and to the pointed position. For example, the angular information may originate from an IMU embedded in the controlling device. In another example, angular information being representative of at least two orientations of the controlling device may be obtained based on image processing of at least two images of the controlling device in respectively the at least two orientations. According to embodiments, the processing module 82 may be configured to determine (e.g., for display) the indication of the pointed position on the display device based on the initial pointed position and on the obtained (e.g., received) angular information.

According to embodiment, the processing device 8 may comprise a display output 84 (e.g., screen) coupled with the processing module 82. The display output 84 (e.g., screen) may be internal or external to the processing device 8. For example, the processing module 82 may be configured to provide a signal suitable for display the indications of various positions on the display output 84 (e.g., screen), that may be pointed by the controlling device.

FIG. 9 represents an exemplary architecture of the processing device 8 described herein. The processing device 8 may comprise one or more processor(s) 910, which may be, for example, any of a CPU, a GPU a DSP (English acronym of Digital Signal Processor), along with internal memory 920 (e.g. any of RAM, ROM, EPROM). The processing device 8 may comprise any number of Input/Output interface(s) 930 adapted to send output information and/or to allow a user to enter commands and/or data (e.g. any of a keyboard, a mouse, a touchpad, a webcam, a display), and/or to send/receive data over a network interface; and a power source 940 which may be external to the processing device 8.

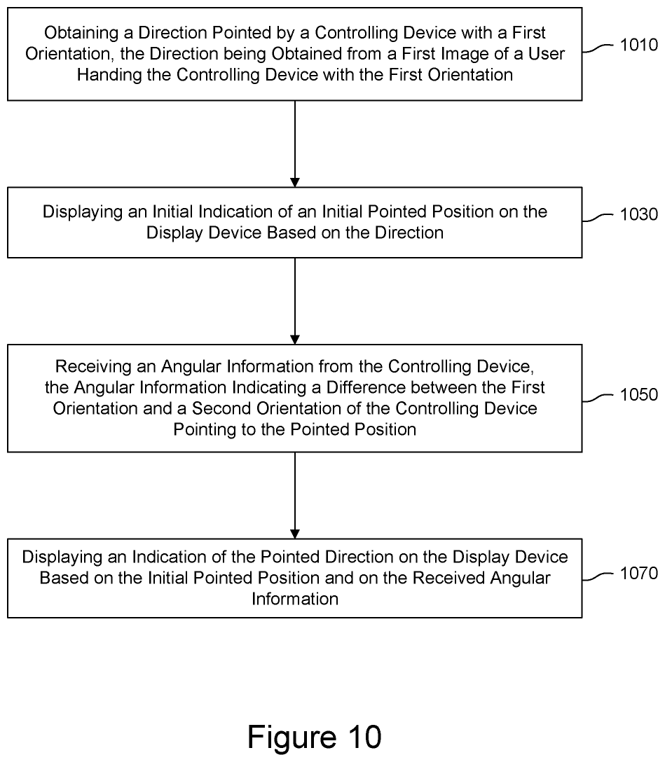

According to embodiments, the processing device 8 may further comprise a computer program stored in the memory 920. The computer program may comprise instructions which, when executed by the processing device 8, in particular by the processor(s) 910, make the processing device 8 carrying out the processing method described with reference to FIG. 10. According to a variant, the computer program may be stored externally to the processing device 8 on a non-transitory digital data support, e.g. on an external storage medium such as any of a SD Card, HDD, CD-ROM, DVD, a read-only and/or DVD drive, a DVD Read/Write drive, all known in the art. The processing device 8 may comprise an interface to read the computer program. Further, the processing device 8 may access any number of Universal Serial Bus (USB)-type storage devices (e.g., “memory sticks.”) through corresponding USB ports (not shown).

According to embodiments, the processing device 8 may be any of a TV set, a set-top-box, a media player, a game console, a desktop computer, a laptop computer, . . . .

FIG. 10 is a diagram illustrating an example of a method for displaying an indication of a pointed position on a display device. According to embodiments, in a step 1010, a direction pointed by a controlling device (e.g., located at a first position) with a first orientation may be obtained from (e.g., based on an image processing of) a first image of a user handing the controlling device with the first orientation (e.g., and located at the first position).

According to embodiments, in a step 1030, an initial indication of an initial pointed position may be displayed on the display device based on the direction. The initial pointed position may be a specific position on the display device that may be pointed by the controlling device at the first position and in the first orientation.

According to embodiments, in a step 1050, angular information may be received from the controlling device. The angular information may indicate a difference between the first orientation and a second orientation of the controlling device pointing to the pointed position.

According to embodiments, in a step 1070, the indication of the pointed position may be displayed on the display device based on the initial pointed position and on the received angular information.

For example, the angular information may be originating from an IMU embedded in the controlling device.

For example, the initial pointed position may be obtained based on a projection of the first position of the controlling device along the obtained direction on the display device. For example, the first position of the controlling device may be obtained based on an image processing of the first image of the user handing the controlling device at the first position and in the first orientation.

For example, the pointed position may be obtained (e.g., and the indication of the pointed position may be displayed) independently from a subsequent projection along a subsequent direction pointed by the controlling device.

For example, any of the initial indication and the indication may be (e.g., determined to be) displayed by superimposing an indicator on content (e.g., to be) displayed on the display device, the indicator being superimposed at respectively any of the initial pointed position and the pointed position on the display device. For example, the indicator (to be superimposed, overlayed) may be any of a luminous point (e.g., emulating a laser pointer), and a cursor (e.g., emulating an air mouse).

In another example, any of the initial indication and the indication may be (e.g., determined to be) displayed by modifying a visual property of an element (e.g., of the content to be) displayed on the display device and located at respectively any of the initial pointed position and the pointed position on the display device. The element of content may be, for example, an element of a user interface, such as any of a logo, a widget, a part of an image, a text, . . . . An element of content may correspond to an area of positions on the display device. The element may be considered as located at a pointed position if it is determined that the pointed position is included in the area of positions of the element. For example, modifying the visual property of an element may comprise any of highlighting, resizing, and surrounding (e.g., framing) the element. Any other type of visual property modification may be applicable to embodiments described herein.

For example, before displaying any of the initial indication and the indication, it may be determined whether the controlling device is pointing to the display device. For example, the controlling device may point to a pointed direction in the plane of the display device that may be outside of the display device. For example, it may be determined that the controlling device is pointing to the display device after having pointed outside of the display device. In such a case (e.g., for any of the initial pointed position and the pointed position), the indication may be determined to be displayed at the center of the display device. For example, the (e.g., initial) indication may be determined to be displayed at the center of the display device by superimposing an indicator (e.g., any of a luminous point, a cursor) at a center position over content to be displayed on the display device. In another example, the (e.g., initial) indication may be determined to be displayed at the center of the display device by modifying a visual property of an element to be displayed at a center position of the display device.

For example, a second position of the controlling device may be obtained, wherein the controlling device may have translated from the first position to the second position for pointing to the pointed position. For example, the pointed position may be further based on the second position of the controlling device.

For example, the second position may be obtained from (e.g., based on an image processing of) a second image of the user handing the controlling device at the second position (e.g., and in the second orientation).

For example, the second position may be obtained from translation information that may be received from the controlling device, indicating a translation of the controlling device from the first position to the second position. The translation information may include (or may be based on) measurement data originating from the IMU embedded in the controlling device.

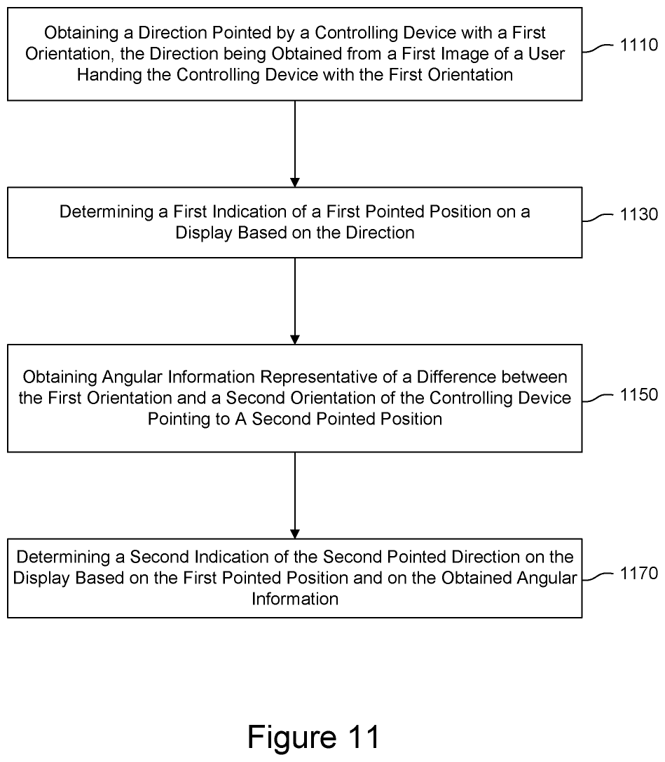

FIG. 11 is a diagram illustrating an example of a method that may be implemented in a processing device. According to embodiments, in a step 1110, a direction pointed by a controlling device (e.g., located at a first position) with a first orientation may be obtained from (e.g., based on an image processing of) a first image of a user handing the controlling device with the first orientation (e.g., and located at the first position).

According to embodiments, in a step 1130, a first indication of a first pointed position on a display may be determined based on the direction. The first pointed position may be a specific position on the display that may be pointed by the controlling device at the first position and in the first orientation.

According to embodiments, in a step 1150, angular information representative of a difference between the first orientation and a second orientation of the controlling device may be obtained. For example, the second pointed position may be pointed on the display by the controlling device in the second orientation.

According to embodiments, in a step 1170, a second indication of the second pointed position on the display may be determined based on the first pointed position and on the obtained angular information.

For example, the angular information may be received from the controlling device.

For example, the angular information may be originating from a sensor embedded in the controlling device.

For example, the first pointed position may be obtained based on a projection of a first position of the controlling device along the obtained direction on the display

For example, the second indication of the second pointed position may be determined independently from a subsequent projection along a subsequent direction pointed by the controlling device.

For example, it may be initially determined that the controlling device may be pointing to the display before determining any of the first indication and the second indication.

For example, the first indication of the first pointed position may be determined to be superimposed on content at a center position on the display.

For example, determining the first indication of the first pointed position may comprise modifying a visual property of an element to be displayed at a center position of the display.

For example, any of the first indication and the second indication may be determined to be superimposed at respectively any of the first pointed position and the second pointed position on the display.

For example, determining any of the first indication and the second indication may comprise modifying a visual property of an element to be displayed at respectively any of the first pointed position and the second pointed position on the display.

For example, modifying the visual property of the element may comprise any of highlighting, resizing and surrounding the element.

For example, a second position of the controlling device may be obtained, e.g., after a translation of the controlling device, and the second pointed position may be further based on the second position of the controlling device.

For example, the second position may be obtained from a second image of the user handing the controlling device at the second position.

For example, the translation information may be received from the controlling device.

For example, a signal suitable for display may be provided (e.g., to the display device) based on the determined second indication of the second pointed position.

### CONCLUSION

While not explicitly described, embodiments described herein may be employed in any combination or sub-combination. For example, embodiments described herein are not limited to the described variants, and any arrangement of variants and embodiments may be used. For example, embodiments described herein are not limited to any of the (e.g., controlled and controlling) devices, user interactions, control commands pose estimations and pointing techniques described herein and any other type of (e.g., controlled/controlling) devices, user interactions, control commands pose estimations and pointing techniques may be applicable to embodiments described herein.

Any characteristic, variant or embodiment described for a method is compatible with an apparatus device comprising means for processing the disclosed method, with a device comprising a processor configured to process the disclosed method, with a computer program product comprising program code instructions and with a non-transitory computer-readable storage medium storing program instructions.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache 30) memory, semiconductor memory devices, magnetic media such as internal hard disks and removable disks, magneto-optical media, and optical media such as CD-ROM disks, and digital versatile disks (DVDs).

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the representative embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (e.g., but not always, in that in certain contexts the choice between hardware and software may become significant) a design choice representing cost vs. efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in line of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method comprising:
obtaining a direction pointed by a controlling device with a first orientation, the direction being obtained from a first image of a user handing the controlling device with the first orientation;
determining a first indication of a first pointed position on a display based on the direction;
obtaining angular information representative of a difference between the first orientation and a second orientation of the controlling device pointing to a second pointed position on the display; and
determining a second indication of the second pointed position on the display based on the first pointed position and on the obtained angular information.

2. The method of claim 1, wherein obtaining the angular information comprises receiving the angular information from the controlling device.

3. (canceled)

4. The method of claim 1, comprising obtaining the first pointed position based on a projection of a first position of the controlling device along the obtained direction on the display.

5. The method of claim 1, wherein the second indication of the second pointed position is determined independently from a subsequent projection along a subsequent direction pointed by the controlling device.

6. The method of claim 1, comprising determining that the controlling device is pointing to the display before determining any of the first indication and the second indication.

7. The method of claim 1, wherein determining the first indication of the first pointed position comprises superimposing the first indication of the first pointed position on content at a center position on the display.

8. The method of claim 1, wherein determining the first indication of the first pointed position comprises modifying a visual property of an element to be displayed at a center position of the display.

9. The method of claim 1, wherein determining any of the first indication and the second indication comprises superimposing any of the first indication and the second indication at respectively any of the first pointed position and the second pointed position on the display.

10. The method of claim 1, wherein determining any of the first indication and the second indication comprises modifying a visual property of an element to be displayed at respectively any of the first pointed position and the second pointed position.

11. The method of claim 8, wherein modifying the visual property of the element comprises any of highlighting, resizing and surrounding the element.

12-16. (canceled)

17. An apparatus comprising a processor configured to:
obtain a direction pointed by a controlling device with a first orientation, the direction being obtained from a first image of a user handing the controlling device with the first orientation;
determine a first indication of a first pointed position on a display based on the direction;
obtain angular information representative of a difference between the first orientation and a second orientation of the controlling device pointing to a second pointed position on the display; and
determine a second indication of the second pointed position on the display based on the first pointed position and on the obtained angular information.

18. The apparatus of claim 17, comprising the display configured to display the determined second indication of the second pointed position.

19. The apparatus of claim 17, wherein the processor is configured to receive the angular information from the controlling device.

20. (canceled)

21. The apparatus of claim 17, wherein the processor is configured to obtain the first pointed position based on a projection of a first position of the controlling device along the obtained direction on the display.

22. The apparatus of claim 17, wherein the processor is configured to determine the second indication of the second pointed position independently from a subsequent projection along a subsequent direction pointed by the controlling device.

23. The apparatus of claim 17, wherein the processor is configured to determine that the controlling device is pointing to the display before determining any of the first indication and the second indication.

24. The apparatus of claim 17, wherein the processor being configured to determine the first indication of the first pointed position comprises the processor being configured to superimpose the first indication of the first pointed position on content at a center position on the display.

25. The apparatus of claim 17, wherein the processor being configured to determine the first indication of the first pointed position comprises the processor being configured to modify a visual property of an element to be displayed at a center position of the display.

26. The apparatus of claim 17, wherein the processor being configured to determine any of the first indication and the second indication comprises the processor being configured to superimpose any of the first indication and the second indication at respectively any of the first pointed position and the second pointed position on the display.

27. The apparatus of claim 17, wherein the processor being configured to determine any of the first indication and the second indication comprises the processor being configured to modify a visual property of an element to be displayed at respectively any of the first pointed position and the second pointed position.
